(19) United States
(12) Patent Application Publication
(10) Pub. No.: US 2026/0269598 A1
(43) Pub. Date: Sep. 10, 2026

(54) OVERLOAD PROTECTION IN AN ELECTRONIC DEVICE

(71) Applicant: SIGNIFY HOLDING B.V., EINDHOVEN (NL)

(72) Inventors: XIUJUAN WU, SHANGHAI (CN); ZHAOTING LI, SHANGHAI (CN); XIAOFENG WANG, SHANGHAI (CN)

(21) Appl. No.: 18/876,292

(22) PCT Filed: Jun. 19, 2023
(86) PCT No.: PCT/EP2023/066368

§ 371 Date: Dec. 18, 2024

(30) Foreign Application Priority Data
Jun. 21, 2022 (WO) PCT/CN2022/100220
Aug. 2, 2022 (EP) 22188331.7

(51) Int. Cl. H02H 5/04; H02H 1/00; H02H 3/20; H02H 7/20; H05B 45/37; H05B 45/56

(52) U.S. Cl. CPC H02H 5/041; H02H 1/0061; H02H 3/202; H02H 7/20; H05B 45/37; H05B 45/56

(57) ABSTRACT

A mechanism for providing overcurrent and/or overvoltage protection to a load of an electronic device (200, 300), as well as providing overtemperature protection to the electronic device. A thermal fuse (150) of the electronic device is adapted to disconnect when an overheat in a first portion (I₁, 311) of the electronic device occurs. The first portion is different from the load and/or un-associating with a portion at the load's side. A heat conversion component (260) is thermally coupled to the thermal fuse of the electronic device. The heat conversion component is electrically coupled to the load, and configured to disconnect the thermal fuse responsive to the value of an electrical property of the load's driving signal (through the load) exceeding a predetermined electrical value. Disconnecting the thermal fuse causes an input signal to the electronic device to be electrically disconnected from the load. The thermal fuse has double function of thermal protection at a portion different from the load and electrical protection at the load.

### FIELD OF THE INVENTION

The present invention relates to the field of electronic devices, and particularly electronic devices with overload protection.

### BACKGROUND OF THE INVENTION

Overload protection is an important aspect of an electronic device, to avoid or reduce breakage, deterioration and/or dangerous operating conditions of the electronic device. An overload occurs when an electrical property such as a current, voltage or power of the electricity supplied to a load of the electronic device exceeds some predetermined value.

One approach for performing overload protection is to make use of an overload protection circuit. An overload protection circuit will usually comprise: a sampling part for sampling an electronic property of the load (e.g., an electrical current); a processing part for comparing the sampled electronic property to a reference; and an execution part for disconnecting the load from a power supply (e.g., using one or more switches such as TRIACs, FETs and/or BJTs).

However, due to the large threshold tolerance for existing switching parts, it is hard to set a suitable threshold, especially for small current application. Such switching circuitry is also bulky, and affects the minimum possible size for the electronic device, as well as draining additional energy.

An improved approach for providing overload protection would therefore be desirable.

### SUMMARY OF THE INVENTION

The invention is defined by the claims.

The inventors have identified that existing overload protection requires a significant amount of circuitry in order to successfully isolate the load from an external power supply when an overload occurs. In particular, it is usually considered necessary to have a sampling part, a processing part and an execution part. This provides a significant burden on the amount of circuitry required, as well as impacting the size of the electronic device.

WO2016000885A1 discloses a tubular LED lamp with a thermal fuse in an end cap of the tubular LED lamp, wherein said thermal fuse is adapted to be blown up by an overheat in the end cap probably caused by arcing between a pin in the end cap and a socket in an lighting fixture due to poor connection therebetween.

US20140185175A1 discloses a thermal protection device for a LED luminaire with a thermal fuse which trips when the fusing temperature is reached.

CN101728120B discloses a device with two independent thermal sensing and break down devices in which there are one thermal sensing tripping device and one fusing break down device.

JP2014220184A discloses a LED device comprising an overcurrent protection device including a thermal fuse and a heating element to be heated by the overcurrent and heat the thermal fuse to cut off the thermal fuse. This device is not meant for overtemperature protection of a part in the LED device except for the heating element itself.

CN111503989A discloses an appliance with a bi-metal switch meant for overcurrent condition and a thermal fuse meant for overtemperature protection.

CN212137973U discloses a LED lighting device to use an inductor to sense overcurrent and to heat a thermal fuse to cut off the thermal fuse. The thermal fuse itself is not used for sensing an overtemperature in a portion of the LED lighting device except for the inductor itself.

The present disclosure proposes an approach to overcome the overheat problem and this overload problem in one go, namely by repurposing the thermal fuse (used for high-temperature protection) to also provide overload protection. In particular, it has been proposed to provide a heat conversion circuit that converts an electrical property of the load into heat thermally coupled to the thermal fuse and to blow up the thermal fuse when the electrical property is over loading. This allows the thermal fuse, used in a first function of overheat protection, to be used as the isolation mechanism for a second function of protection against an overload condition. Most importantly, the overheat protection of the thermal fuse is meant for an overheat occurs at a portion, of the whole device, different from a portion that relates to the occurrence of the overload condition. Thus the thermal fuse is reused for two distinct occurrences of overheat and overload in different positions of the whole device.

According to examples in accordance with an aspect of the invention, there is provided an electronic device comprising: a power supply configured to provide a load driving signal from an input signal; a load powered by the load driving signal; a first portion different from the load and/or un-associating with a portion at the load's side; and a thermal fuse electrically coupled between the power supply and the input signal and thermally coupled to the first portion, the thermal fuse being configured to be disconnected responsive to a temperature, at the first portion, exceeding a first temperature threshold and thereby electrically disconnect the input signal from the power supply.

The electronic device is characterized by further comprising a heat conversion component electrically coupled to the load and thermally coupled to the thermal fuse, and configured to generate, at the thermal fuse, a temperature that disconnects the thermal fuse responsive to a value of an electrical property of the load driving signal exceeding a predetermined electrical value and thereby electrically disconnect the input signal from the power supply.

Embodiments thereby provide an approach for using a thermal fuse, which is used to disconnect an input signal from the electronic device when an overheat in the electronic device occurs, to also decouple or disconnect the input signal from the (remainder of the) electronic device when the overload condition occurs in a load of the electronic device, wherein the overheat does not happen at the load/overload condition. One underlying technique adopted by the present invention is that a single fuse performs a dual function of thermal protection at the first portion decoupled from the load/load driving signal as well as over current/voltage protection at the load/load driving signal. In short, the first portion is not where the load is or the load driving signal flows.

Preferably, the first portion is a physical place in/on the electronic device, and does not include/associate with a portion at the load side. Thus the first portion is different from the heat conversion component and the load. Here “does not associate” and “un-associate” effectively means that the first portion is decoupled, preferably thermally decoupled, from the portion at the load side, in other words, the temperature of the load does not substantially affect the first portion or the thermal fuse. What, of the load, affects the first portion or the thermal fuse is the electrical property of the load.

Even more preferably, the first portion is adapted to be coupled to an external power source. Thus the thermal fuse is used for protecting overtemperature at the coupling between the electronic device and the external power source. Meanwhile, the electrical property of the load causes an overloading at the load, inside the electronic device. Thus the thermal fuse is reused for both an abnormal condition between the electronic device and the external power source and an abnormal condition within the electronic device, and its usage is broad.

Please note that this is just one embodiment and the first portion can also be a portion that is not intended to couple to the external power source. For example, the first portion could be a critical component such as the power MOSFET of the power supply which component needs thermal protection. Meanwhile the heat conversion component is associated with the load side, different from the power supply side, which needs overloading protection.

In some examples, the electrical property is a current through the load. Overcurrent protection is an important consideration in the design of many electronic devices, to protect against potentially dangerous effects (e.g., breakage or damage of the load or possibly the ignition of fires). Thus the present application is beneficial to prevent overcurrent at the load.

To mitigate the overcurrent problem, the heat conversion component may comprise a resistive element connected electrically in series with the load. The resistive element is configured to generate a heat responsive to the current flow through the resistance and the load; and thermally coupled to the thermal fuse to provide the heat to the thermal fuse thereby generate, at the thermal fuse, the temperature that disconnects the thermal fuse.

A resistive element (i.e., a resistor) provides a simple and effective mechanism for both detecting the current through a load and converting the current through the load to heat. In particular, the power dissipated (and therefore a heat output) by a resistive element is squarely proportional to the current through the load, making a resistive element a highly sensitive approach for performing overcurrent protection.

The resistance of a resistive element can also be readily selected or tuned to target a particular overcurrent condition (e.g., a particular predetermined current value). A resistive element therefore provides flexibility in manufacturing or creating desirable characteristics for overcurrent protection.

A resistive element also provides a low-cost (materially and financially) technique for providing a heat conversion component. This embodiment mitigates the complexity in the known above-mentioned overcurrent protection that involves dedicated comparators.

In some examples, the electrical property is a voltage across the load. An overvoltage is another important consideration in performing overload protection, e.g., to avoid the presence of high voltages across the load, improving a safety for an individual/person in the vicinity of the load.

Suitable heat conversion components include a thermocouple, a Peltier device or a resistive element connected in parallel with the load.

In some examples, the electrical property is a power consumed by the load. This approach can be used to avoid the load consuming excess power.

The electronic device may further comprise an input interface, at the first portion, configured to receive the input signal from an external power source.

In such examples, the thermal fuse may be electrically coupled between the power supply and the input interface; and the input interface and/or at the first portion and the thermal fuse may be thermally coupled, such that a temperature, at the input interface, exceeding the first temperature threshold disconnects the thermal fuse. Optionally said first portion is suspectable to be heated due to the external power source thus the thermal fuse protects the electronics device. Alternatively, the heat source may be inside the electronic device and said first portion may also intend to heat the external power source, thus the thermal fuse protects the external power source.

In this way, the input interface is at the first portion. A portion of the input interface for an electronic device is a highly susceptible location for high temperatures (e.g., due to arcing from an external power supply to nodes/pins of an improperly connected input interface). Such like that the plastic body of a plug or socket of an appliance is often melt. Thus it is quite essential to provide a temperature protection for the input interface's location.

In some examples, the electronic device is (configured as) a tubular LED lamp comprising an end cap, as the first portion, thermally connected to the input interface; the load comprises one or more LEDs; the input interface extends through the end cap and is adapted to contact the external power source at a position external to the end cap; and the thermal fuse is placed internally in the end cap such that a temperature of the input interface that exceeds the first temperature threshold heats the end cap which in turn heats the thermal fuse so as to disconnect the thermal fuse.

This provides a particularly advantageous use-case scenario for overheat and overload protection using the proposed technique. In particular, the available size for overload protection components in a tubular LED lamp is reduced, due to the compact nature of the devices, whilst high electrical power is still present. Using the proposed technique for repurposing the thermal fuse is therefore particularly useful.

The input interface may comprise at least one pin susceptible to be heated by arcing between the pin and the external power source due to a poor contact with the external power source.

The electronic device may be configured for use with an electronic ballast.

The holder of a fluorescent lamp lighting fixture may not be very reliable. The holder may wear out and may be unable to contact the pin firmly, resulting in arcing. Thus, the present application is beneficial to be used in a/the tubular LED lamp designed for electronic ballasts.

In one embodiment, the power supply connects the at least one pin of the input interface to the load without performing active power conversion. This approach provides an electronic device (particularly a tubular LED lamp) that is adapted for the specific use with an electronic ballast, providing a particularly useful use-case scenario. The electronic ballast is a current-regulator per se thus the power supply without an active power conversion is able to drive the LED(s) with the electronic ballast.

The power supply may comprise a rectifying arrangement for rectifying the input signal to produce the load driving signal.

The output of the electronic ballast is an alternating current and the LED(s) is/are a unidirectional component. Thus, a rectifying arrangement is useful to fully utilize the output of the electronic ballast.

The power supply may comprise a bypass/shunt capacitor to bypass a part of the input signal from the load and provide the remaining part of the input signal to the load as the load driving signal.

Sometimes the current from the electronic ballast is more than that needed by the LEDs, thus the bypass/shunt capacitor is useful to regulate the current to the LED.

Both the rectifying arrangement and the bypass/shunt capacitor are passive components that do not perform any active conversion of the power from the electronic ballast.

The input interface may comprise: a first interface node for connection to a first node of the power supply; and a second interface node for connection to a second node of the power supply. The thermal fuse may be coupled between the first interface node and the power supply.

The electronic device may further comprise a second thermal fuse, different to the thermal fuse, coupled between the second interface node and the power supply. This provides an electronic device that is able to be powered, e.g., using a differential signal. This may be useful for a number of environments. This embodiment provides thermal protection for the other interface, thus both interfaces have respective thermal protection.

Preferably, the electronic device comprises a further heat conversion component electrically coupled to the load and thermally coupled to the second thermal fuse, and configured to generate, at the second thermal fuse, a temperature that disconnects the second thermal fuse responsive to a value of an electrical property of the load driving signal exceeding a predetermined electrical value and thereby electrically disconnect the input signal from the power supply.

This embodiment re-uses the thermal protection on the second interface also for overloading protection, and any one or both of the thermal fuses can cut off the electronic device from the power source and provides more safety or a greater safety margin.

The heat conversion component may be thermally coupled to the thermal fuse using thermal glue or thermal adhesive. This provides an effective and low cost technique for ensuring good and/or effective thermal coupling between the thermal fuse and the heat conversion component.

Preferably, the thermal coupling of the heat conversion component is such that no less than 10% of the heat generated by the heat conversion component is lost by the thermal coupling to the thermal fuse, e.g., no less than 5%, e.g., no less than 1%. This approach ensures that the occurrence of an overload in the load (i.e., the value of the electrical property exceeding a predetermined threshold) is accurately and reliably detected and used to trigger the disconnecting of the thermal fuse.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 illustrates an existing electronic device;

FIG. 2 illustrates a proposed electronic device;

FIG. 3 illustrates a tubular LED lamp; and

FIG. 4 shows the tubular LED lamp of FIG. 3 inserting into a lamp holder.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a mechanism for providing overcurrent and/or overvoltage protection to a load of an electronic device. A heat conversion component is thermally coupled to a thermal fuse of the electronic device wherein the thermal fuse has been adapted to be disconnect when an overheat in a first portion of the electronic device occurs. The heat conversion component is also electrically coupled to the load, and configured to disconnect the thermal fuse responsive to the value of an electrical property of a load driving signal (through the load) exceeding a predetermined electrical value. Disconnecting the thermal fuse causes an input signal to the electronic device to be electrically disconnected from the load.

The present invention is based on the realization that a heat conversion component can be used as both an electrical property sensor and a trigger/control for a thermal fuse. This means that a thermal fuse can be used to perform a dual purpose of thermal protection in first portion and overloading protection in the load, different from the first position per se.

Embodiments can be employed for any suitable electronic device for which both temperature/heat protection and overload protection for a load of the electronic device is desired. For instance, the electronic device may be an LED lamp such as a tubular LED lamp.

In the context of the present invention, the verb “to fuse” or “to disconnect” is used to mean “electrically fuse”—i.e., trip or break so as to prevent a current flow through a thermal fuse.

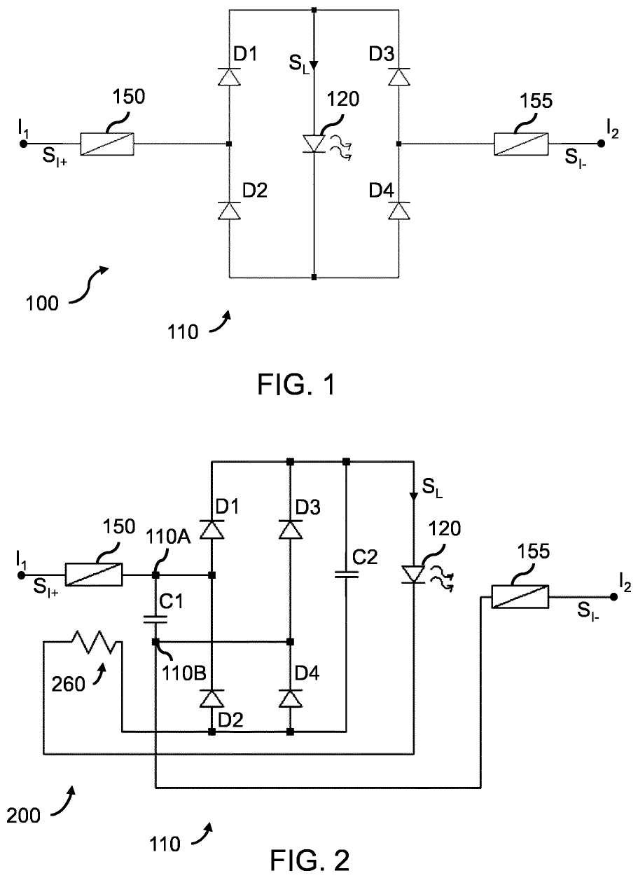

FIG. 1 illustrates an electronic device 100 comprising a thermal fuse 150 according to existing configurations. The electronic device 100 comprises a power supply 110, a load 120 and the thermal fuse 150. The electronic device 100 further comprises an input interface I₁, I₂ and a second thermal fuse 155.

The power supply 110 is configured to provide a load driving signal S_{L} from an input signal S_{I+}. The power supply 110 may further (as illustrated) provide the load driving signal S_{L} from a second input signal S_{I-}. The input signal and the second input signal may together act as a differential signal. It will be appreciated more than two input signals may be received at/by the power supply and converted into the load driving signal, according to well-known principles.

The input signal (and optional second input signal) is provided at an input interface I₁, I₂ by an external power source (not shown), such as a mains power supply, a driving arrangement or an electrical ballast, such as those used for lighting applications. In particular, the input signal may be provided to a first interface node I₁ and (if present) the second input signal may be provided to a second interface node I₂. Although not illustrated, one or more further input signals may be provided to a respective one or more further interface nodes.

The power supply 110 is configured to convert the input signal(s) S_{I+}, S_{I-} into the load driving signal S_{L}. An alternative definition for the power supply 110 is therefore a conversion circuit. The illustrated power supply 110 comprises a rectifying arrangement D1, D2, D3, D4 for rectifying the input signal(s) (at the input interface I₁, I₂) to produce the load driving signal.

The load 120 is configured to receive the load driving signal S_{L} and be driven accordingly. Suitable examples for a load include an LED arrangement comprising one or more light emitting diodes (LEDs). Other suitable examples will be apparent to the skilled person.

The thermal fuse is electrically coupled between the power supply 110 and the input signal S_{I+}, i.e., between the input interface I₁, I₂ and the power supply 110. Specifically, the thermal fuse 150 is electrically coupled between the first interface node I₁ of the input interface and a first node 110A of the power supply.

The thermal fuse 150 is thermally coupled to a first portion of the electronic device. The thermal fuse 150 disconnects (i.e., trips or breaks) responsive to a temperature at the first portion exceeding a first predetermined temperature threshold. The disconnecting of the thermal fuse electrically disconnects the input signal from the power supply, i.e., electrically disconnects a portion of the input interface from the power supply.

The skilled person will appreciate that any one of a number of portions of the electronic device can be used as the first portion. For instance, the first portion may be a portion subject to heating (e.g., a portion most proximate to the external power supply or a portion to be exposed to external heat conditions). Other examples will be apparent to the person skilled in the art.

A suitable example of a first predetermined temperature threshold is 150° C. or 125° C., although other temperatures will be apparent to the skilled person. For instance, the first predetermined temperature threshold may be any temperature greater than 100° C.

If the input interface comprises more than one interface nodes (e.g., the second interface node I₂), a respective thermal fuse 150, 155 may connect each interface node to the power supply, e.g., a node of the power supply. For instance, if the input interface comprises a second interface node I₂ as illustrated, a second thermal fuse 155 may connect the second interface node I₂ to a second node 110B of the power supply 110.

Each thermal fuse is thermally coupled to a particular portion of the electronic device. Each thermal fuse 150 will disconnect (i.e., trips or breaks) responsive to a temperature at its particular portion exceeding a particular predetermined temperature threshold. The disconnecting of the thermal fuses electrically disconnects a corresponding input signal from the power supply, i.e., electrically disconnects a portion of the input interface from the power supply.

FIG. 2 illustrates an electronic device 200 comprising a thermal fuse 150 according to a proposed approach.

The electronic device differs from the electronic device previously described by further comprising a heat conversion component 260. The heat conversion component 260 is electrically coupled to the load. The heat conversion component 260 is also thermally coupled to the thermal fuse.

The heat conversion component 260 is configured to generate heat responsive to changes in an electrical property of the load driving signal (across/through the load 120).

In particular, the heat conversion component is configured to generate, at the thermal fuse, a temperature that disconnects the thermal fuse responsive to a value of the electrical property exceeding a predetermined electrical value. The disconnecting of the thermal fuse 150 electrically disconnects the input signal S_{I+} from the power supply 110.

Various options for the electrical property could be used in different embodiments, including a current through the load, a voltage across the load and/or a power dissipated by the load.

One suitable example of a heat conversion component for detecting a current through the load is a resistive element connected electrically in series with the load. The power dissipated by such a resistive element as a result from the current will generate a heat, the magnitude of which changes/is responsive to changes in the current through the load.

One suitable example of a heat conversion component for detecting a voltage across the load is a resistance across a resistive element connected electrically in parallel with the load. The power dissipated by such a resistive element as a result from the voltage across the load will generate a heat, the magnitude of which changes/is responsive to changes in the voltage across the load.

Another suitable example of a heat conversion component for detecting a voltage across the load is a thermocouple. A thermocouple can be configured to produce a voltage-dependent heat (e.g., at a particular side or plate of the thermocouple) as a result of the Seebeck effect.

Yet another example of a heat conversion component for detecting a voltage across the load is a Peltier device, which is able to generate heat responsive to a voltage. A voltage applied across a Peltier device will build up a difference in temperature between the two sides of the Peltier, which can be exploited for use as a heat conversion component.

One suitable example of a heat conversion component for detecting a power dissipated by the load comprises a combination of a first resistive element connected in series with the load and a second resistive element connected in parallel with the load. This combines the two approaches previously described.

Other suitable examples will be apparent to the skilled person.

If used, the resistive element(s) may be formed of any suitable material that generates heat responsive to a current flow through the resistive element, and can be labelled a heating element. Examples of suitable materials include: metallic materials (such as nichrome; kanthal; or cupronickel) and ceramic/semi-conductor materials (such as silicon carbide; silicon nitride). Those skilled in the art understand that the common off-shelf resistor is also suitably applicable for use in embodiments, as the temperature of such a resistor changes responsive to a power dissipated by the resistor. Other examples will be apparent to the skilled person.

In one working example, as illustrated, the heat conversion component comprises a resistive element connected in series with the load. The heat dissipated by such a resistive element will be responsive to the current through the load (i.e., the electrical current amplitude of the load driving signal).

By way of explanation, it is noted that when the load is overdriven, the current through the load will increase. It is therefore possible to use one or more resistive elements (e.g., resistors) to convert this current into a temperature. It is noted that the power P (measurable in Watts W) dissipated by a resistive element is I²R, i.e.:

$$P = {I}^{2} R \qquad ( 1 )$$

where I is the current (measurable in amps/amperes A) through the resistive element and R is the resistance (measurable in Ohms Ω). Thus, if the current is twice times of normal, the power of the resistor is four times of normal condition.

The temperature of resistor is closely related to the power dissipated by the resistor. Thus, with a current twice a “normal” current, so the resistor temperature is four times more than normal condition. In this way, the heat conversion component is able to amplify the current.

By thermally coupling the heat conversion component to the thermal fuse, only one additional component (the heat conversion component) is required to electrically disconnect the electronic device from an external power supply—as the thermal fuse can be repurposed to act as the electrically disconnecting element in additional to the original purpose of being a thermally disconnecting element. This approach thereby reduces or minimizes the number of components required to electrically disconnect the electronic device from an external power source, by using the heat conversion component to allow the thermal fuse to perform a double duty. Thus, fewer components are required and space occupied by the electronic device can be reduced.

It has previously been explained how the heat conversion component 260 is thermally coupled to the thermal fuse 150. Various approaches for thermally coupling a heat conversion component 260 to a thermal fuse will be apparent to the skilled person. For instance, the heat conversion component may be thermally coupled to the thermal fuse using thermal glue or thermal adhesive. As another example, the heat conversion component may be directly coupled to the thermal fuse by a heat conductive element, e.g., a metal.

Preferably, the thermal coupling of the heat conversion component is such that no more than 10% of the heat generated by the heat conversion component is lost by the thermal coupling to the thermal fuse, e.g., no more than 5%, e.g., no more than 1%. This can be achieved through the use of appropriately quantities of the thermal glue/adhesive and/or sizes of heat conductive elements, as well as appropriate positioning of the heat conversion component with respect to the thermal fuse.

It has previously been explained how the thermal fuse 150 disconnects (i.e., trips or breaks) responsive to a temperature at a first portion exceeding a first predetermined temperature threshold.

The first portion may, for instance, be the first interface node or a region encompassing the first interface node. Thus, the input interface and thermal fuse may be thermally coupled, such that a temperature, at the input interface, exceeding the first predetermined temperature threshold disconnects the thermal fuse.

Similarly, it has been previously explained how if the input interface comprises more than one interface node (e.g., the second interface node I₂), a respective thermal fuse 150, 155 may connect each interface node to the power supply, e.g., a node of the power supply. In this scenario, each thermal fuse is thermally coupled to a particular portion of the electronic device and will fuse (i.e., trip or break) responsive to a temperature at its particular portion exceeding a particular predetermined temperature threshold.

The particular portion for each thermal fuse may be the interface node associated with that thermal fuse, i.e., the interface node that the thermal fuse connects to the power supply. Thus, each pair of input interface node and thermal fuse may be thermally coupled together, such that a temperature, at each input interface node, that exceeds a particular predetermined temperature threshold will fuse the corresponding thermal fuse (i.e., the thermal fuse electrically connected thereto).

FIG. 2 also illustrates an optional feature of the power supply, namely a bypass/shunt capacitor C1. The bypass/shunt capacitor acts to bypass a part of the input signal from the load and provide the remaining part of the input signal to the load as the load driving signal.

FIG. 2 also illustrates another optional feature of the power supply, namely a smoothing capacitor C2. The smoothing capacitor is configured to smooth the signal produced by the rectifying arrangement D1, D2, D3, D4 to produce a DC-like voltage for the load 120.

Preferably, the power supply 110 is configured to connect/convert the input signal (e.g., the input interface) to/for the load without performing active power conversion. This provides an electronic device configured for use with an electronic ballast.

It will be appreciated that the first portion does not include the load and/or comprises only parts or portions whose temperature is unaffected or negligibly affected by the electrical property of the load driving signal. Put another way, changes in the electrical property of the load driving signal may be insufficient to cause a non-negligible temperature rise or change in the first portion.

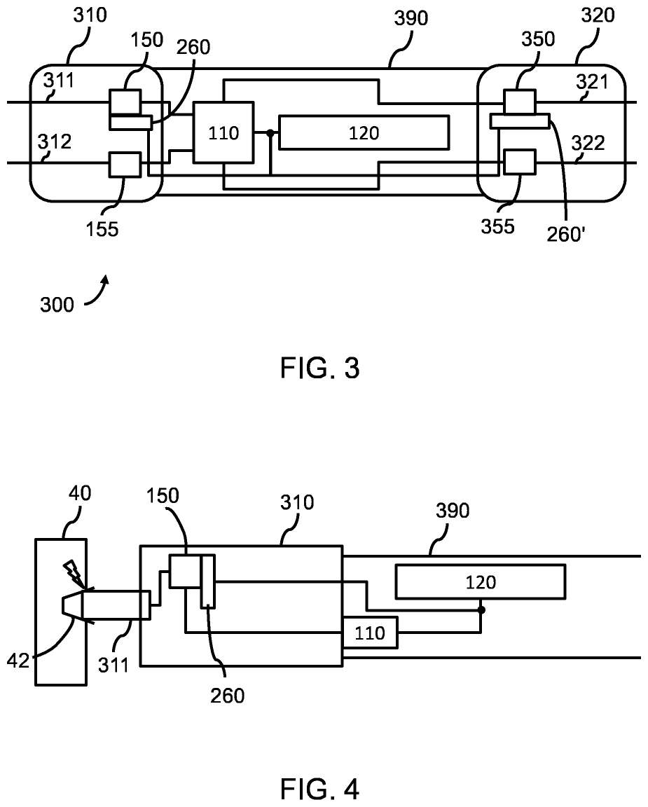

FIG. 3 illustrates an embodiment of an electronic device 300, which is configured as a tubular LED lamp. For the tubular LED lamp the load 120 comprises one or more light emitting diodes (LEDs). FIG. 4 shows the tubular LED lamp inserted into a lamp holder 40.

The tubular lamp 300 comprises at least one end cap 310, 320. An input interface extends through the end cap for connection to an external power source. The end cap is holding the input interface and is thus thermally coupled to the input interface. The thermal fuse 150 is positioned within the end cap and is thus also thermally coupled with the end cap, and is positioned such that a temperature of the input interface that exceeds the first temperature threshold heats the end cap which in turn heats the thermal fuse so as to disconnect the thermal fuse.

In this way, the end cap 310 acts as a thermal coupling mechanism for coupling heat or thermal energy from the input interface to the thermal fuse. The end cap and the thermal fuse may, for instance, be thermally coupled together (e.g., using thermal glue/adhesive).

The tubular lamp 300 may comprise a lamp body 390, which houses at least the load 120 and optionally the power supply 110. Alternatively, the power supply may be housed in the end cap or end caps.

The input interface may comprise one or more pins 311, 312, 321, 322, i.e., at least one pin. Each pin may be configured for connecting or contacting an external power source to obtain the input signal(s) therefrom. As shown in FIG. 4, the pin 311 is configured to contact a socket 42 in the lamp holder 40. The socket provides a connection for the tubular lamp 300 to an external power source. Those skilled in the art understand that the contact of the pin and the fluorescent lamp holder/socket may not be good/secure, e.g., may be loose. Each pin may, for instance, be susceptible to be heated by arcing between the pin and the external power source due to a poor contact with the external power source/socket 42. The arcing is shown by the lighting icon in FIG. 4. It will be appreciated that each pin may act as an interface node, such that a heating at a pin causes a heating of the thermal fuse.

In this way, the first portion of electronic device may be a portion containing one or more pins of the input interface, e.g., the one or more pins of the input interface.

As previously explained, the power supply 110 may be configured to connect/convert the input signal (e.g., the input interface) to/for the load without performing active power conversion. Accordingly, the conversion power supply circuit may connect the at least one pin of the input interface to the load without performing active power conversion.

Most importantly, FIGS. 3 and 4 show the heat conversion component 260 thermally coupled with the thermal fuse 150. FIGS. 3 and 4 also show that the heat conversion component 260 is electrically connected to the load 120 via a schematic wire, and the specific connection can be the way shown in FIG. 2. The heat conversion component 260 convert the electrical property of the load driving signal into a heat. When the electrical property is overloading, the resulted heat on the heat conversion component 260 is sufficient to heat the thermal fuse 150 and disconnect the thermal fuse 150.

FIG. 3 also conceptually illustrates additional input interface nodes, with corresponding additional thermal fuses 350, 355. Each respective thermal fuse 150, 155, 350, 355 connects a respective interface node to the power supply 110. Each thermal fuse may be thermally coupled to a particular portion of the electronic device and will fuse (i.e., trip or break) responsive to a temperature at its particular portion exceeding a particular predetermined temperature threshold.

FIG. 4 just shows one end of the tubular LED lamp comprising the end cap 310 and a portion of the lamp body 390.

FIG. 3 also shows a further heat conversion component 260′ electrically coupled to the load 120 and thermally coupled to the additional thermal fuse 350. The further heat conversion component 260′ may be electrically in series with the load in the same way of the heat conversion component 260: namely there are two resistors in series with the LED 120. This heat conversion component 260′ can disconnect the additional thermal fuse 350 responsive to the value of the electrical property of the LED current exceeding the predetermined electrical value and thereby electrically disconnect the input signal from the power supply.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa.

Any reference signs in the claims should not be construed as limiting the scope.

1. An electronic device comprising:
a power supply configured to provide a load driving signal from an input signal;
a load powered by the load driving signal;
a first portion different from the load and/or un-associating with a portion at the load's side;
a thermal fuse electrically coupled between the power supply and the input signal and thermally coupled to the first portion, the thermal fuse being configured to be disconnected responsive to a temperature, at the first portion, exceeding a first temperature threshold and thereby electrically disconnect the input signal from the power supply; and
a heat conversion component electrically coupled to the load and thermally coupled to the thermal fuse, and configured to generate, at the thermal fuse, a temperature that disconnects the thermal fuse responsive to a value of an electrical property of the load driving signal exceeding a predetermined electrical value and thereby electrically disconnect the input signal from the power supply, wherein said heat conversion component is different from the first portion.

2. The electronic device of claim 1, wherein the first portion is adapted to be coupled to an external power source that provides the input signal, the power supply is adapted to connect to the first portion at an input and to provide the load driving signal at an output, and
the electrical property is a current through the load.

3. The electronic device of claim 2, wherein the heat conversion component comprises a resistive element connected electrically in series with the load, the resistive element being:
configured to generate a heat responsive to the current flow through the resistance and the load; and
thermally coupled to the thermal fuse to provide the heat to the thermal fuse thereby generate, at the thermal fuse, the temperature that disconnects the thermal fuse.

4. The electronic device of claim 1, wherein the electrical property is a voltage across the load.

5. The electronic device of claim 1, wherein the electrical property is a power consumed by the load.

6. The electronic device of claim 2, wherein the first portion comprises an input interface configured to receive the input signal from the external power source, wherein:
the thermal fuse is electrically coupled between the power supply and the input interface; and
the input interface and/or the first portion and thermal fuse are thermally coupled, such that a temperature, at the input interface, exceeding the first temperature threshold disconnects the thermal fuse, wherein said first portion is suspectable to be heated by the external power source or is capable of heating the external power source.

7. The electronic device of claim 6, wherein:
the electronic device is a tubular LED lamp comprising an end cap, holding the first portion and thermally connected to the input interface;
the load comprises one or more LEDs;
the input interface extends through the end cap and is adapted to contact the external power source at a position external to the end cap; and
the thermal fuse is placed internally in the end cap such that a temperature of the input interface that exceeds the first temperature threshold heats the end cap which in turn heats the thermal fuse so as to disconnect the thermal fuse.

8. The electronic device of claim 6, wherein the input interface comprises at least one pin susceptible to be heated by arcing between the pin and the external power source due to a poor contact with the external power source.

9. The electronic device of claim 8, configured for use with an electronic ballast, wherein the power supply connects the at least one pin of the input interface to the load without performing active power conversion.

10. The electronic device of claim 9, wherein the power supply comprises a rectifying arrangement for rectifying the input signal to produce the load driving signal.

11. The electronic device of claim 10, wherein the power supply further comprises a bypass/shunt capacitor to bypass a part of the input signal from the load and provide the remaining part of the input signal to the load as the load driving signal.

12. The electronic device of claim 6, wherein the input interface comprises:
a first interface node for connection to a first node of the power supply; and
a second interface node for connection to a second node of the power supply.

13. The electronic device of claim 12, wherein the thermal fuse is coupled between the first interface node and the power supply.

14. The electronic device of claim 13, further comprising a second thermal fuse, different to the thermal fuse, coupled between the second interface node and the power supply, and
a further heat conversion component electrically coupled to the load and thermally coupled to the second thermal fuse, and configured to generate, at the second thermal fuse, a temperature that disconnects the second thermal fuse responsive to the value of the electrical property of the load driving signal exceeding the predetermined electrical value and thereby electrically disconnect the input signal from the power supply.

15. The electronic device of claim 1, wherein the heat conversion component is thermally coupled to the thermal fuse using thermal glue or thermal adhesive.
